(19) United States
(12) Patent Application Publication
(10) Pub. No.: US 2007/0159458 A1
(43) Pub. Date: Jul. 12, 2007

(54) Mobile communication terminal and user interface method thereof

(76) Inventor: Sung-kyoon Yoon, Seongnam-si (KR)

Correspondence Address: CANTOR COLBURN, LLP, 55 GRIFFIN ROAD SOUTH, BLOOMFIELD, CT, 06002, US

(21) Appl. No.: 11/482,278

(22) Filed: Jul. 7, 2006

(30) Foreign Application Priority Data
Dec. 28, 2005 (KR) 10-2005-0132125

(51) Int. Cl. G09G 5/00

(52) U.S. Cl. 345/156; 707/3

(57) ABSTRACT

A user interface method of a mobile communication terminal is provided, including: (a) interpreting a key inputted from a user to extract a number; (b) retrieving content corresponding to the number from at least one content stored in the mobile communication terminal or downloaded from a server; and (c) outputting the number and the corresponding content to a display unit.

This application claims the priority of Korean Patent Application No. 2005-132125, filed on Dec. 28, 2005, in the Korean Intellectual Property Office, the disclosure of which is incorporated herein in its entirety by reference.

### BACKGROUND OF THE INVENTION

1. Field of the Invention

The present invention relates to a user interface method of a mobile communication terminal and, more particularly, to a user interface method of using content stored in a mobile communication terminal or content downloaded from a server to display characteristic images on the mobile communication terminal, and the mobile communication terminal providing the user interface method.

2. Description of Related Art

A mobile communication terminal, such as a personal mobile phone, a personal digital assistant (PDA), or an International Mobile Telecommunications-2000 (IMT-2000), includes a user interface device having an input unit, such as a keypad or a touch-screen, and an output unit, such as a liquid crystal display (LCD) unit. When a user inputs a key through the input unit, the key is displayed on the LCD unit. For instance, when the user enters a phone number, the phone number is displayed on the LCD unit.

However, the above-mentioned user interface method has a problem that it is used to display simple information but cannot be used to fully display what the users desire to represent. Accordingly, users are increasingly demanding more characteristic and interesting interface methods.

With recent development of multimedia technologies, users represent their own individualities through mobile communication terminals by using photos as background images in the mobile communication terminals, or by using content downloaded from servers providing supplemental services as background images in the mobile communication terminals.

### SUMMARY OF THE INVENTION

The present invention provides a user interface method that uses content stored in a mobile communication terminal or downloaded from a server to represent characteristic images on the mobile communication terminal.

According to an aspect of the present invention, there is provided a mobile communication terminal including: an interpreting unit interpreting a key inputted from a user to extract a number; a retrieving unit retrieving content corresponding to the number from at least one content stored in the mobile communication terminal or downloaded from a server; and an output control unit controlling outputting the number and the corresponding content to a display unit.

The content may include identification information and a multimedia object consisting of image, sound, moving image, or animation.

The content may be made by means of an additional authoring tool.

The content may include information required in playing the content, such as frame information containing width, height, and position of a frame, sound information, or compression information.

The output control unit may play the multimedia object based on the information required in playing the content, such as frame information, sound information or compression information included in the content.

The number may be a communication service number of a phone number, a number consisting of a communication service number and an exchange number, or a number consisting of a communication service number, an exchange number and a remaining number of a phone number, and the retrieving unit may retrieve phone numbers containing the extracted number, and retrieve contents corresponding to the phone numbers.

When there is a plurality of phone numbers containing the extracted number, the output control unit may sequentially display the contents corresponding to the phone numbers.

The mobile communication terminal may further include a call connection unit that makes a call to a phone number corresponding to content displayed upon pushing a selection button when the contents are sequentially displayed.

When the number is a hot key, a phone number corresponding to the hot key may be retrieved and displayed together with content corresponding to the phone number.

The interpreting unit may extract a character corresponding to a key inputted from a user, and the key may be 0, 1, 2, 3, 4, 5, 6, 7, 8, 9, *, or # that is arranged in a keypad of the mobile communication terminal.

According to another aspect of the present invention, there is provided a mobile communication terminal including: an interpreting unit extracting a phone number of a caller upon receiving a message, or extracting a phone number of a receiver upon sending a message; a retrieving unit retrieving content corresponding to the phone number of the caller or receiver from at least one content stored in the mobile communication terminal or downloaded from a server; and an output control unit controlling outputting the phone number of the caller or receiver and the corresponding content to a display unit.

According to another aspect of the present invention, there is provided a user interface method of a mobile communication terminal, including: (a) interpreting a key inputted from a user to extract a number; (b) retrieving content corresponding to the number from at least one content stored in the mobile communication terminal or downloaded from a server; and (c) outputting the number and the corresponding content to a display unit.

The operation (a) may include: (a11) interpreting the key to extract a communication service number of a phone number, a number consisting of a communication service number and an exchange number, or a number consisting of a communication service number, an exchange number and a remaining number of a phone number; and (a12) retrieving phone numbers containing the extracted number.

The content may be multimedia content corresponding to a phone number containing the extracted number, and the operation (c) may sequentially display the contents when there is a plurality of phone numbers containing the extracted number.

The operation (c) may display the phone numbers containing the extracted number and the retrieved contents.

The user interface method may further include: (d) making a call to a phone number corresponding to content displayed upon pushing a selection button when the contents are sequentially displayed.

The operation (a) may extract a character corresponding to a key inputted from a user, and the key may be 0, 1, 2, 3, 4, 5, 6, 7, 8, 9, *, or # that is arranged in a key pad of the mobile communication terminal.

According to another aspect of the present invention, there is provided a user interface method of a mobile communication terminal, including: (x) extracting a phone number of a caller upon receiving a message, or extracting a phone number of a receiver upon sending a message; (y) retrieving content corresponding to the phone number of the caller or receiver from at least one content stored in the mobile communication terminal or downloaded from a server; and (z) outputting the phone number of the caller or receiver and the corresponding content to a display unit.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of user interface of a mobile communication terminal according to an embodiment of the present invention;

FIG. 2 is a flow chart of a user interface method of a mobile communication terminal according to an embodiment of the present invention;

FIG. 3 is a detailed flow chart of the operation ‘A’ shown in FIG. 2;

FIG. 4 is a detailed flow chart of the operation ‘B’ shown in FIG. 2;

FIGS. 5A to 5C illustrate a user interface method according to an embodiment of the present invention;

FIG. 6 is a detailed flow chart of the operation ‘A’ shown in FIG. 2 according to another embodiment of the present invention;

FIG. 7 illustrates a user interface method according to another embodiment of the present invention;

FIGS. 8A to 8C illustrate a method of automatically mapping content stored in a mobile communication terminal;

FIGS. 9A and 9B illustrate a method of manually mapping content stored in a mobile communication terminal;

FIG. 10 illustrates a method of making content to be downloaded using another authoring tool;

FIG. 11 is a detailed flow chart of the operation ‘A’ shown in FIG. 2 according to another embodiment of the present invention; and

FIG. 12 illustrates a user interface method according to another embodiment of the present invention.

### DETAILED DESCRIPTION OF THE INVENTION

Exemplary embodiments in accordance with the present invention will now be described in detail with reference to the accompanying drawings. In the following description, a detailed description of known functions and configurations incorporated herein will be omitted when it may make the subject matter of the present invention rather unclear.

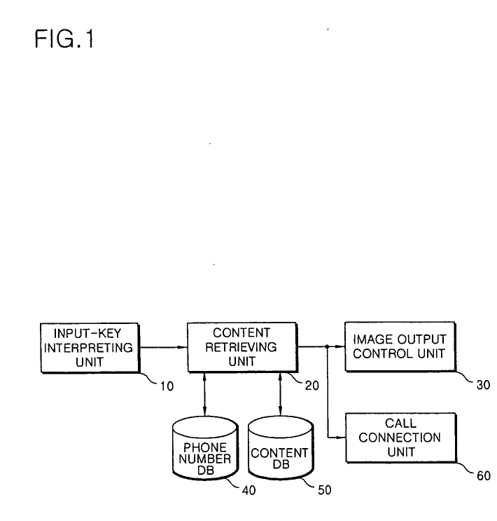

FIG. 1 is a block diagram of user interface of a mobile communication terminal according to an embodiment of the present invention.

The user interface of a mobile communication terminal includes an input-key interpreting unit 10, a content retrieving unit 20, an image output control unit 30, a phone number database 40, and a content database 50. The user interface may further include a call connection unit 60.

The input-key interpreting unit 10 interprets a key inputted from a user through an input unit such as a keypad or a touch-screen. As described below, the key may be interpreted as a phone number, a hot key, or one of characters on the keypad or touch-screen. The content retrieving unit 20 retrieves content stored in the mobile communication terminal or downloaded from a server, which corresponds to the number interpreted by the input-key interpreting unit 10. When the key is recognized as a phone number, phone numbers including a number corresponding to the key are retrieved from the phone number database 40. In addition, contents corresponding to the retrieved phone numbers are retrieved from the content database 50. The image output control unit 30 outputs the retrieved contents to a display unit of the mobile communication terminal. When a plurality of contents is retrieved, the contents are sequentially displayed. When the user selects one of the contents, the call connection unit 60 automatically connects a call to a phone number corresponding to the selected content.

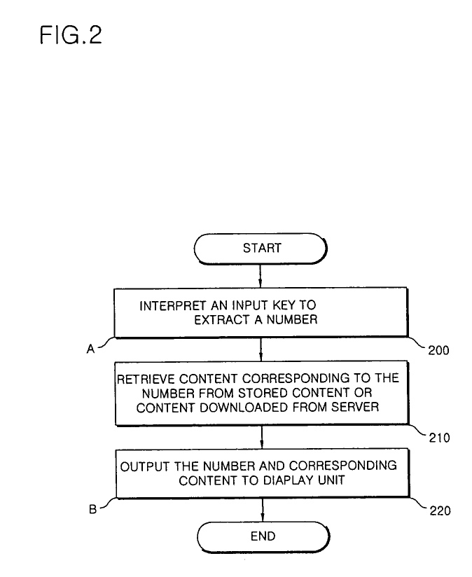

FIG. 2 is a flow chart of a user interface method of a mobile communication terminal according to an embodiment of the present invention.

When a user inputs a key through the input unit of the mobile communication terminal, the input-key interpreting unit 10 interprets the key to extract a number (operation 200 or ‘A’). The content retrieving unit 20 retrieves contents corresponding to the extracted number from the content database 50 storing contents in the mobile communication terminal or contents downloaded from a server (operation 210). The image output control unit 30 sequentially displays the corresponding contents together with the extracted number (operation 220).

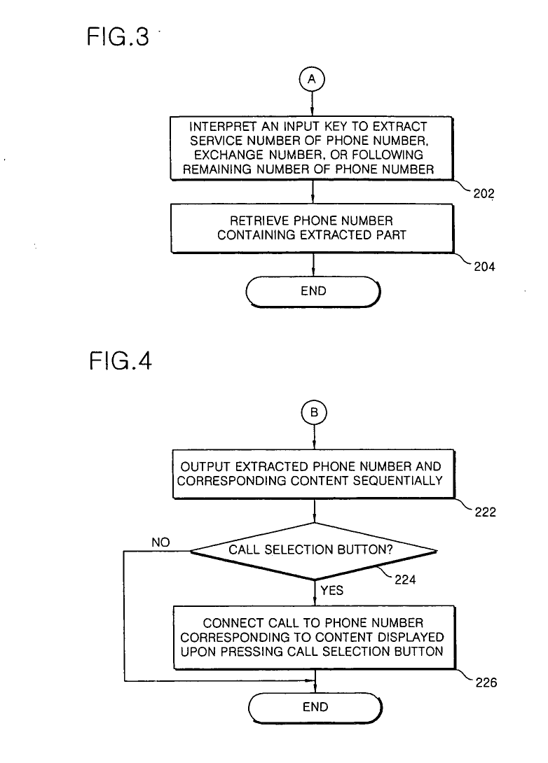

FIG. 3 is a detailed flow chart of the operation. ‘A’ of FIG. 2. FIG. 4 is a detailed flow chart of the operation ‘B’ of FIG. 2.

When the input key is recognized as a phone number, the input-key interpreting unit 10 interprets the key to extract a communication service number, such as 010, 011, 016, 017, or 019, an exchange number, or the following remaining number of the phone number (operation 202). The content retrieving unit 20 retrieves phone numbers including the extracted number from the phone number database 40 (operation 204). In addition, the content retrieving unit 20 retrieves contents corresponding to the retrieved phone numbers from the content database 50 (operation 210). The image output control unit 30 sequentially displays the extracted phone numbers and the corresponding contents (operation 222). When the contents are sequentially displayed and the user presses a call selection button, the call connection unit 60 connects a call to a phone number corresponding to the selected content (operation 226).

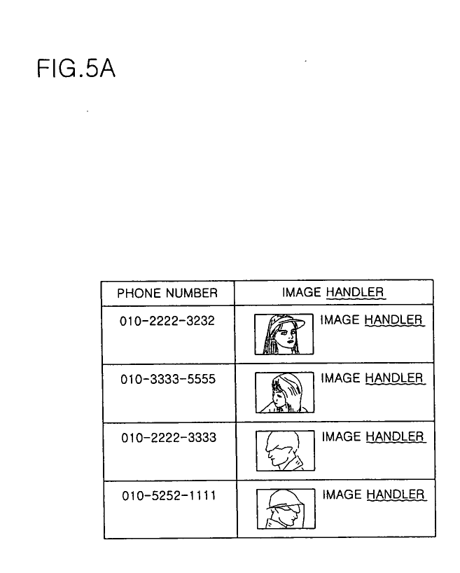

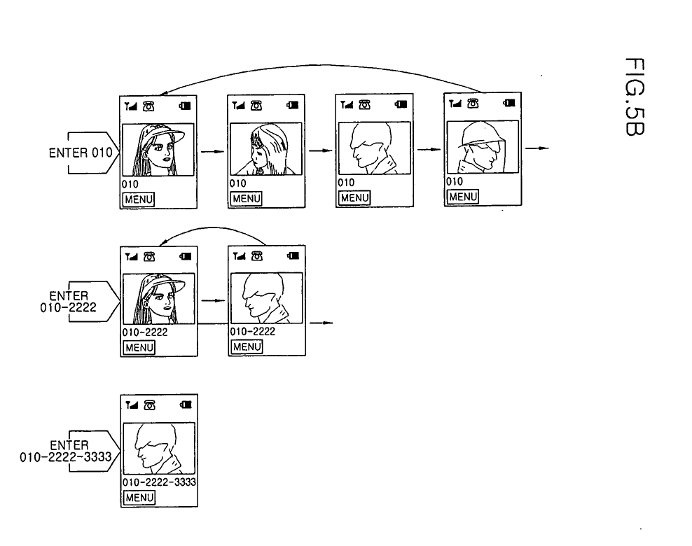

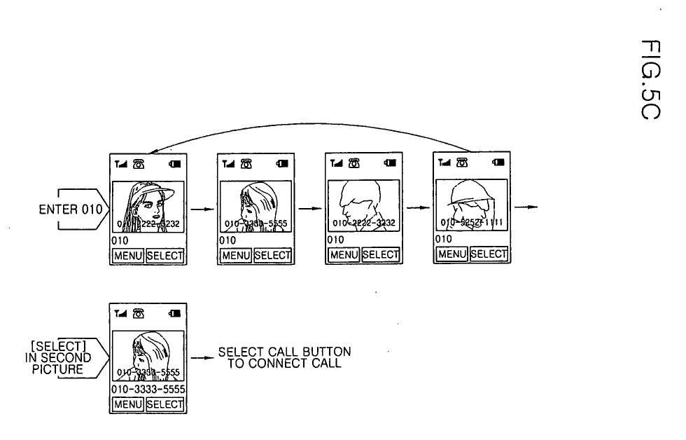

FIGS. 5A to 5C illustrate pictures stored in a phone directory.

FIG. 5A illustrates a content mapping table storing phone numbers and corresponding pictures. The content mapping table stores phone numbers, such as 010-2222-3333, and corresponding pictures or picture handlers. Information such as the phone numbers and pictures may be stored in the phone number database 40 or content database 50.

Referring to FIG. 5B, when a user presses a number ‘010’ through the input unit to make a call, the number is interpreted as a communication service number. Next, phone numbers containing the communication service number ‘010’ are retrieved, and corresponding pictures are sequentially displayed from the content mapping table, phone number database, or content database. When there is a plurality of phone numbers including the number, corresponding pictures are sequentially displayed, giving an animation effect. When the user further presses an exchange number ‘2222’ following the number ‘010’, pictures corresponding to a combination of the communication service number and the exchange number are displayed on the display unit. When the user presses a full phone number ‘010-2222-3333’, a picture that corresponds to the full phone number and is registered in the phone directory is displayed on the display unit.

The above-mentioned procedure may be applied to a case when the user presses a hot key of a phone number.

As shown in FIG. 5C, phone numbers including the number ‘010’ and pictures corresponding to the phone numbers are displayed on the display unit. Accordingly, the above-mentioned procedure allows the user to see pictures displayed on the display unit and easily search for a desired phone number without the need to remember the phone numbers.

As shown in FIG. 5C, when a plurality of pictures corresponding to a plurality of phone numbers containing the number ‘010’ is displayed and, at that time, the user presses a selection button to select a picture corresponding to a phone number ‘010-333-5555’, the phone number is indicated on an input window. When the user further presses a call connection button, a call is automatically connected to the phone number.

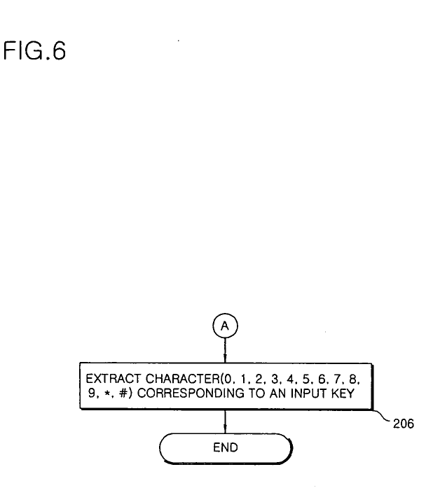

FIG. 6 is a detailed flow chart of the operation ‘A’ of FIG. 2 according to another embodiment of the present invention.

In the present embodiment, an input key is recognized as a character (operation S206). That is, the input key is recognized as one of characters 0, 1, 2, 3, 4, 5, 6, 7, 8, 9, *, and # in the input unit.

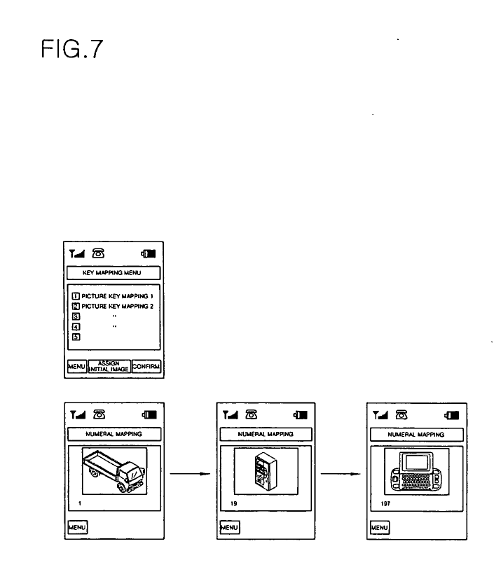

Referring to FIG. 7, in a case when pictures taken by a mobile communication terminal having a camera, or pictures or multimedia content, such as graphics, moving images, or animation, downloaded from a server providing supplemental services are mapped to keys of the mobile communication terminal, contents mapped to keys pressed by the user are displayed. When the content is displayed, an effect of coming flying-and-scattered, a rolling-up effect, or a rotating effect may be applied to the displayed content.

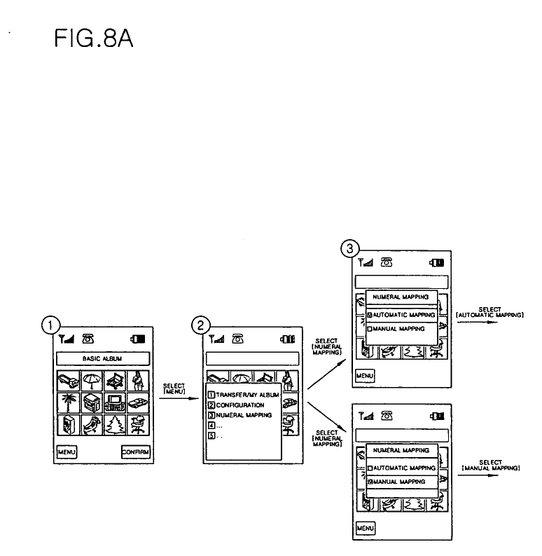

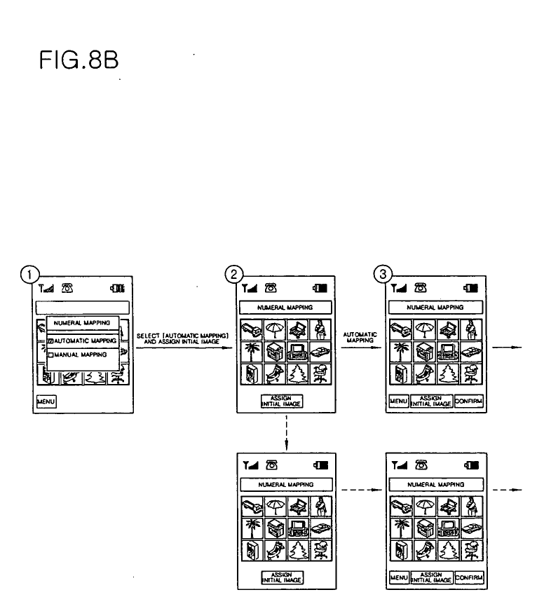

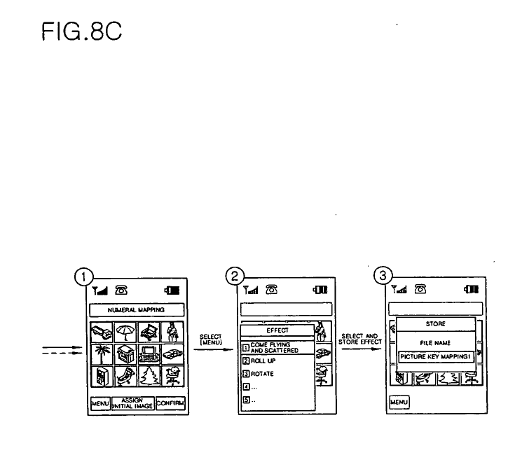

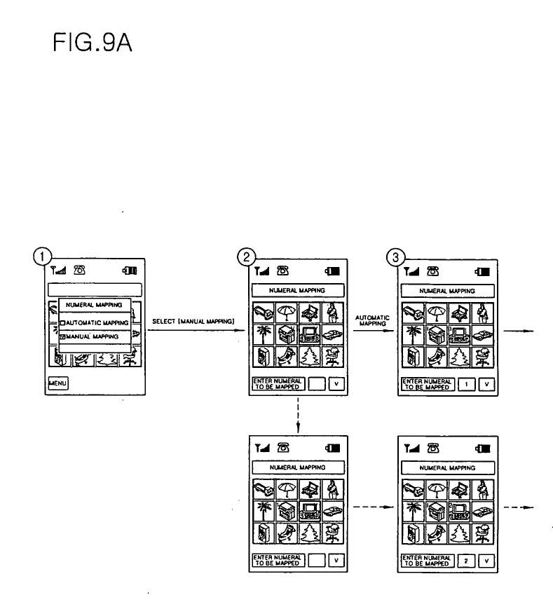

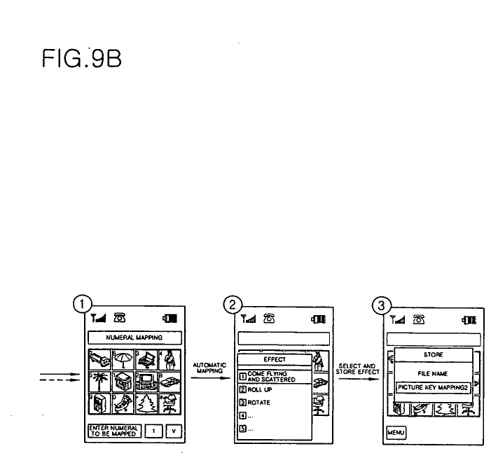

Examples of a method of mapping the content to the key include an automatic mapping method shown in FIGS. 8A to 8C and a manual mapping method shown in FIGS. 9A and 9B.

Referring to FIG. 8A, when a menu button is selected in the content database 50 storing pictures taken by a camera and a numeral mapping menu is selected, an automatic mapping or manual mapping method can be selected. The automatic mapping method implies that when a picture to be mapped to a first key is assigned, the following pictures are assigned to the following keys automatically and sequentially. The manual mapping method implies that a user directly maps individual pictures to individual keys.

FIGS. 8B and 8C are views for explaining the automatic mapping method.

Referring to FIG. 8B, when an automatic mapping menu is selected and a picture to be mapped to a first key is assigned, numerals of 1˜# are represented on the first to last pictures. When there are more than twelve pictures, the numerals are mapped only to the first to twelfth pictures.

Referring to FIG. 8C, after completing the numeral mapping operation, an effect menu may be selected to apply display effects to pictures. For example, the effect of coming flying-and-scattered, rolling-up effect, or rotating effect may be applied to a picture when it is displayed. After selecting the display effect, a file consisting of a picture and a numeral, which are mapped to each other, is stored in a content mapping table.

FIGS. 9A and 9B are views for explaining the manual mapping method.

Referring to FIG. 9A, after selecting a manual mapping operation in the numeral mapping menu, a picture to be mapped to a first key is marked with a check mark. At this time, when two or more pictures are marked to be mapped to a single numeral, an animation effect may be achieved. When a numeral to be mapped to the marked picture is input in a numeral blank, the check mark is changed to the numeral. That is, content files may be mapped to a numeral in the manual mapping method. As shown in FIG. 9B, it is possible to apply various display effects to the pictures that are manually mapped.

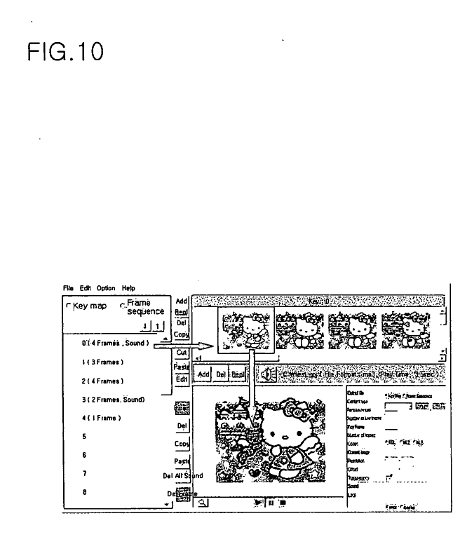

FIG. 10 is a view for explaining a method of making content to be downloaded using another authoring tool.

Instead of an additional content mapping table, content downloaded from a server may be made using another authoring tool. Accordingly, the content may include a key, which is assigned as identification information of the content, and the type of content, such as image, sound, moving image, or animation. The content may further include frame information, such as the width, height, and position of each frame, required in displaying the content, sound information, or compression information. The content made with the authoring tool includes the information required in displaying the content and the identification information, and is stored in the server. The mobile communication terminal downloads the content from the server. When a number is input from the keypad of the mobile communication terminal, content having content identification information corresponding to the number is automatically displayed using information contained in the content and required in displaying the content. That is, the content downloaded from the server can be played using the identification information and the display information contained in the content without an additional mapping table.

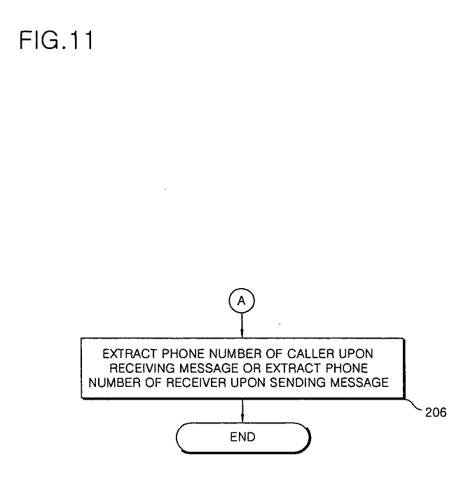

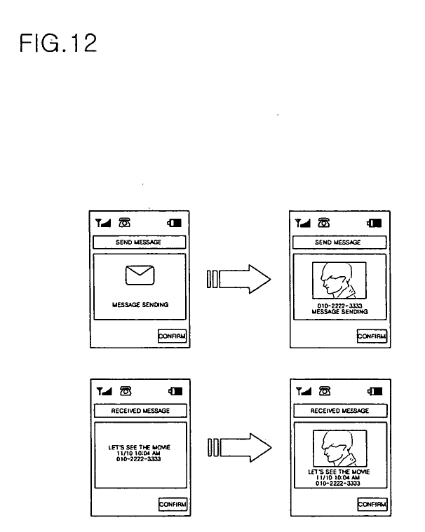

FIG. 11 is a detailed flow chart of the operation ‘A’ shown in FIG. 2 and FIG. 12 is a user interface method according to another embodiment of the present invention.

Referring to FIG. 11, a phone number of a caller is extracted from an SMS or MMS message upon receiving the message, or a phone number of a receiver is extracted from the message upon sending the message (operation 208).

Referring to FIG. 12, when a message is sent, a phone number of a receiver is extracted, content corresponding to the phone number is retrieved, and the phone number and the corresponding content are displayed on a display unit. In addition, when a message is received, a phone number of a caller is extracted, content corresponding to the phone number is retrieved, and the phone number and the corresponding content are displayed on a display unit.

The user interface method of a mobile communication terminal according to the present invention may be written with computer programs. Codes and code segments constituting the programs can be readily deduced by computer programmers skilled in the art. Further, the programs are stored in computer readable media, read and executed by computers to implement the user interface method of the mobile communication terminal. Examples of the computer readable media include magnetic recording media, optical recording media, and carrier wave media.

As apparent from the above description, according to the present invention, it is possible to provide a user interface method that uses content stored in a mobile communication terminal or content downloaded from a server to display characteristic images on the mobile communication terminal, and the mobile communication terminal providing the user interface method.

That is, content related to a phone number or a numeral is retrieved from pictures taken by a camera phone, or from multimedia content stored in other terminals or downloaded from a server, and is displayed on a display unit. Accordingly, a user can provide a characteristic interface on the mobile communication terminal. In addition, it is possible to make efficient use of pictures taken by the camera phone.

Further, when part of a phone number is input, contents corresponding to phone numbers containing the inputted part are sequentially displayed on the display unit. Accordingly, even though a user cannot remember a phone number, the user can search for a desired phone number, viewing displayed pictures.

While the present invention has been described with reference to exemplary embodiments thereof, it will be understood by those skilled in the art that various changes in form and details may be made therein without departing from the scope of the present invention as defined by the following claims.

What is claimed is:

1. A mobile communication terminal comprising:
an interpreting unit interpreting a key inputted from a user to extract a number;
a retrieving unit retrieving content corresponding to the number from at least one content stored in the mobile communication terminal or downloaded from a server; and
an output control unit controlling outputting the number and the corresponding content to a display unit.

2. The mobile communication terminal of claim 1, wherein the content includes identification information and a multimedia object consisting of image, sound, moving image, or animation.

3. The mobile communication terminal of claim 2, wherein the content is made by means of an additional authoring tool.

4. The mobile communication terminal of claim 2, wherein the content includes information required in playing the content, such as frame information containing width, height, and position of a frame, sound information, or compression information.

5. The mobile communication terminal of claim 4, wherein the output control unit plays the multimedia object based on the information required in playing the content, such as frame information, sound information or compression information included in the content.

6. The mobile communication terminal of claim 1,
wherein the number is a communication service number of a phone number, a number consisting of a communication service number and an exchange number, or a number consisting of a communication service number, an exchange number and a remaining number of a phone number, and
the retrieving unit retrieves phone numbers containing the extracted number, and retrieves contents corresponding to the phone numbers.

7. The mobile communication terminal of claim 1, wherein when there is a plurality of phone numbers containing the extracted number, the output control unit sequentially displays the contents corresponding to the phone numbers.

8. The mobile communication terminal of claim 7, further including a call connection unit that makes a call to a phone number corresponding to content displayed upon pushing a selection button when the contents are sequentially displayed.

9. The mobile communication terminal of claim 1, wherein when the number is a hot key, a phone number corresponding to the hot key is retrieved and displayed together with content corresponding to the phone number.

10. The mobile communication terminal of claim 1, wherein the interpreting unit extracts a character corresponding to a key inputted from a user, and the key is 0, 1, 2, 3, 4, 5, 6, 7, 8, 9, *, or # that is arranged in a keypad of the mobile communication terminal.

11. A mobile communication terminal comprising:
an interpreting unit extracting a phone number of a caller upon receiving a message, or extracting a phone number of a receiver upon sending a message;
a retrieving unit retrieving content corresponding to the phone number of the caller or receiver from at least one content stored in the mobile communication terminal or downloaded from a server; and
an output control unit controlling outputting the phone number of the caller or receiver and the corresponding content to a display unit.

12. A user interface method of a mobile communication terminal, comprising:
(a) interpreting a key inputted from a user to extract a number;
(b) retrieving content corresponding to the number from at least one content stored in the mobile communication terminal or downloaded from a server; and
(c) outputting the number and the corresponding content to a display unit.

13. The user interface method of claim 12, wherein the content includes identification information and a multimedia object consisting of image, sound, moving image, or animation.

14. The user interface method of claim 12, wherein the content is made by means of an additional authoring tool.

15. The user interface method of claim 12, wherein the content includes information required in playing the content, such as frame information containing width, height, and position of a frame, sound information, or compression information.

16. The user interface method of claim 15, wherein the operation (c) plays the multimedia object based on the information required in playing the content, such as frame information, sound information, or compression information included in the content.

17. The user interface method of claim 12, wherein the operation (a) comprises:
(a11) interpreting the key to extract a communication service number of a phone number, a number consisting of a communication service number and an exchange number, or a number consisting of a communication service number, an exchange number and a remaining number of a phone number; and
(a12) retrieving phone numbers containing the extracted number.

18. The user interface method of claim 12,
wherein the content is multimedia content corresponding to a phone number containing the extracted number, and
the operation (c) sequentially displays the contents when there is a plurality of phone numbers containing the extracted number.

19. The user interface method of claim 18, wherein the operation (c) displays the phone numbers including the extracted number and the retrieved contents.

20. The user interface method of claim 19, further including:
(d) making a call to a phone number corresponding to content displayed upon pushing a selection button when the contents are sequentially displayed.

21. The user interface method of claim 12, wherein when the number is a hot key, a phone number corresponding to the hot key is retrieved and displayed together with content corresponding to the phone number.

22. The user interface method of claim 12,
wherein the operation (a) extracts a character corresponding to a key inputted from a user, and
the key is 0, 1, 2, 3, 4, 5, 6, 7, 8, 9, *, or # that is arranged in a key pad of the mobile communication terminal.

23. A user interface method of a mobile communication terminal, comprising:
(x) extracting a phone number of a caller upon receiving a message, or extracting a phone number of a receiver upon sending a message;
(y) retrieving content corresponding to the phone number of the caller or receiver from at least one content stored in the mobile communication terminal or downloaded from a server; and
(z) outputting the phone number of the caller or receiver and the corresponding content to a display unit.
